(19) United States
(12) Patent Application Publication
(10) Pub. No.: US 2010/0190480 A1
(43) Pub. Date: Jul. 29, 2010

(54) METHOD AND SYSTEM FOR SURVEILLANCE BASED ON VIDEO-CAPABLE MOBILE DEVICES

(75) Inventors: Yongping ZHENG, Shanghai (CN); Huafeng Mai, Shanghai (CN); Shih-Kuang Tsai, Shanghai (CN)

Correspondence Address: MCDERMOTT WILL & EMERY LLP, 600 13TH STREET, N.W., WASHINGTON, DC, 20005-3096, US

(73) Assignees: INVENTEC APPLIANCES(SHANGHAI) CO.,LTD.; INVENTEC APPLIANCES CORP.

(21) Appl. No.: 12/550,671

(22) Filed: Aug. 31, 2009

(30) Foreign Application Priority Data
Jan. 23, 2009 (CN) 200910045885.6

(51) Int. Cl. H04M 3/42; H04N 7/18

(52) U.S. Cl. 455/414.1; 455/556.1; 348/143; 348/E07.085

(57) ABSTRACT

A method for an audio or video (A/V) capable mobile device includes responding to a call from a mobile device at a locale where the A/V capable mobile device is placed for monitoring an area of the locale, and determining whether the call corresponds to a designated identification for activating the A/V capable mobile device to monitor the area of the locale. The method also includes responding to the call from the mobile device if the call corresponds to the designated identification to activate the A/V capable mobile device. Upon responding to the call, the A/V capable mobile device monitors the area of the locale.

### BACKGROUND

1. Technical Field

The present teaching relates generally to surveillance. Specifically, the present teaching relates to method and system for surveillance using mobile devices.

2. Discussion of Related Art

With the advancement of electronics, means to perform surveillance become more and more diverse. Currently, most surveillance systems adopt a configuration in which there is a central monitoring site or a monitoring center connected with various installed monitoring sensors. In this configuration, the central monitoring site is responsible for the operation of the entire system, collecting information from sensors installed at various surveillance locations. Such collected information includes video or audio information. In addition, the central monitoring site may also send monitoring instructions to different sensors to control the operation or behavior of these sensors. In this configuration, the location of the sensors are fixed so that the entire surveillance system is static. Sensors can only collect information from locations where they are installed and a user can see the monitored locations only from the central monitoring site. In the meantime, the costs for implementing and maintain this type of static surveillance system are high.

With the development and ever increasing popularity of mobile phones, it has become feasible to utilize such mobile phones as a monitoring terminal to surveillance certain areas within the field of view. Existing applications include system that achieve surveillance by utilizing Short Message Service (SMS) via General Packet Radio Services/Code Division Multiple Access (GPRS/CDMA) data service and Multimedia Messaging Service (MMS). In addition, real-time video based surveillance systems emerged that is based on registration servers. There are disadvantages associated with existing systems. For example, a system based on SMS can not support video based monitoring and MMS based system, although possible to have visual information, can only transmit static images, which often can not precisely reflect the dynamic events occurring at the monitored site in real time. Furthermore, systems based on registration servers are often complex, expensive, and difficult to use. Due to these reasons, it is not possible to have wide surveillance applications with efficiency in terms of both cost and ease to use.

Therefore, there is a need to develop a surveillance scheme which overcome the above problems and provide a wide range of users a flexible, convenient, and cost effective way for surveillance.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary diagram of a system in which mobile devices are used collaboratively for surveillance, according to an embodiment of the present teaching;

FIGS. 2(a)-2(c) depicts an exemplary systems in which different types of mobile devices work collaboratively for surveillance, according to an embodiment of the present teaching;

FIG. 3 illustrates exemplary types of electronic devices with audio or video capabilities;

FIG. 4 depicts an exemplary diagram of a system in which mobile devices collaborate to conduct surveillance via electronic devices connected through networks, according to an embodiment of the present teaching;

FIGS. 5(a) and 5(b) show exemplary interfaces of a mobile device in connection with surveillance functions, according to an embodiment of the present teaching;

FIG. 6 illustrates exemplary instructions used in connection with surveillance via collaborative mobile devices, according to an exemplary embodiment of the present teaching;

FIG. 7 depicts an exemplary communication protocol and information flow between different mobile devices to enable surveillance, according to an embodiment of the present teaching;

FIG. 8 is a flowchart of an exemplary process in which a mobile device capable of being used as a surveillance terminal is remotely controlled by another mobile device for surveillance, according to an embodiment of the present teaching;

FIG. 9 is a flowchart of an exemplary process in which a mobile device operating as a surveillance terminal interacts with another mobile device for surveillance control, according to an embodiment of the present teaching;

FIG. 10 is a flowchart of an exemplary process in which a mobile device remotely controls another mobile device to conduct surveillance, according to an embodiment of the present teaching; and

FIG. 11 is a flowchart of an exemplary process in which a mobile device remotely activated by another mobile device controls various aspects of surveillance, according to an embodiment of the present teaching.

### DETAILED DESCRIPTION

The present teaching is for flexible and cost effective surveillance via mobile devices. With mobile devices, it is feasible to flexibly and cost effectively configure mobile devices to be placed at locations where surveillance is desired. Certain communication channels can be designated for activating and controlling various aspects of remote surveillance based on mobile devices.

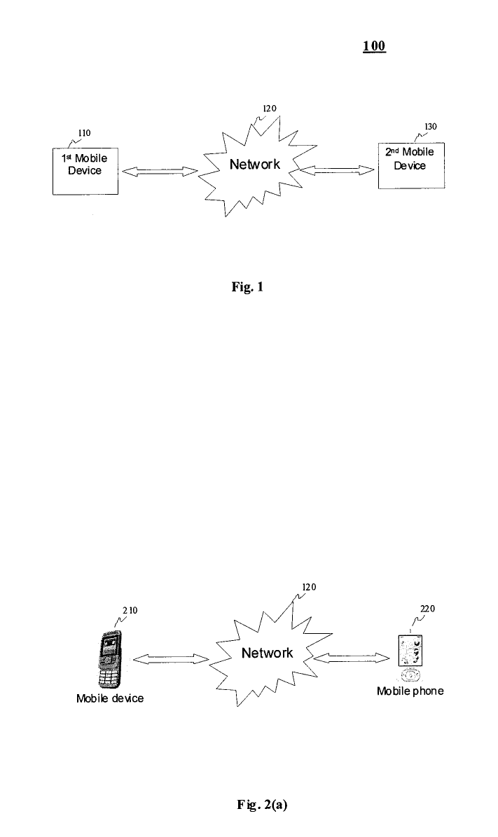

FIG. 1 depicts an exemplary system 100 in which a first and second mobile devices 110 and 130, respectively, are used collaboratively for surveillance via a network 120, according to an embodiment of the present teaching. In this configuration, the second mobile device is placed near an area of a locale where surveillance is desired. The second mobile device 130 is a terminal that is capable of acquiring audio, image, or video information from the area of the locale where it is configured. The first mobile device is configured to collaboratively work with the second mobile device to achieve remote surveillance. Here, remote surveillance refers to a scenario where the first and second mobile devices are communicative via a network 120. This network 120 can be a local area network (LAN), a wide area network (WAN), the Internet, a wired network, a wireless network, a virtual network, a proprietary network, or any combination thereof.

In operation, a user can configure the second mobile device 130 near an area where surveillance is desired. Such configured second mobile device 130 is to collaboratively work with the first mobile device to achieve surveillance. For instance, the user may leave the locale and take the first mobile device 110. In this manner, the first and second mobile devices are separated yet can communicate with each other via the network 120. In some embodiments, the user may utilize the first mobile device 110, while away from the locale where the second mobile device 130 is placed, to remotely active the second mobile device 130 to invoke certain functions for monitoring the area of the locale where the second mobile device is configured. The user may also use various functions available on the first mobile device 110 to remotely control how the second mobile device 130 is to surveillance the area of interest. In this configuration, the first mobile device 110 may act in a more active role and control the operation of the second mobile device 130. While the second mobile device 130 may play a more subordinate role in this collaborative mode of surveillance operation.

In some embodiments, the second mobile device 130 may be configured to play a more actively role. Once configured to monitor an area, the second mobile device 130 may be activated to continuously surveillance the area prior to activating the first mobile device 110. Information acquired during the surveillance may be analyzed and used to detect certain pre-determined events. If a certain pre-determined event is detected, the second mobile device 130 may initiate a communication with the first mobile device 110. When the communication channel between the second and first mobile devices is established, the second mobile device 130 may then transmit certain information to the first mobile device 110. Such transmitted information may be the information acquired from the area under surveillance or other information, e.g., a description of the event detected. Once the first mobile device is activated, the user of the first mobile device can then use the first mobile device 110 to monitor the area under surveillance remotely.

As discussed herein, the second mobile device 130 is configured to conduct surveillance of an area by acquiring information related to the area. Such an area can be any locale in any setting. For example, it can be a room or an area of a room at a home, an office, or any location where surveillance is desired. The surveillance may be based on information acquired from area of the locale where the mobile device 130 is placed. Such acquired information may be audio, images, or video. Depending on how the second mobile device 130 is configured, the acquisition of information by the second mobile device 130 may be directed to a single modality or multiple modalities. For example, the second mobile device may be configured to acquire only audio without image or video information. It may also be configured to acquire both audio and video. It may also be configured to acquire audio in a continuous manner but acquire snapshot pictures with a certain time interval.

A workable configuration of the second mobile device 130 may be determined based on various considerations such as bandwidth available or desired mode of operation. For example, if the bandwidth is limited, the second mobile device 130 may be configured to acquire only audio information in connection with the area under surveillance. But if it is need to have a silence monitoring of the surveillance area using the first mobile device, the second mobile device 130 may be configured to acquire only images or send only images to the first mobile device 110 but store locally the audio information.

A configuration made to the second mobile device 130 may also be dynamically changed remotely by a user via the first mobile device 110 through control functions available on the first mobile device 110. For example, if the user is in a meeting, the user may configure the second mobile device 130 to send only images or video without sound. Once the user is out of the meeting, the user may reconfigure the second mobile device 130 to send audio information. Via the first mobile device 110, a user may also change the role played by the second mobile device 130 from one operational mode to another. For instance, if the second mobile device 130 is initially configured to act in a passive operational mode (need to be activated by the first mobile device and merely send information to the first mobile device once activated), it can be dynamically re-configured by a user via the first mobile device 110 to enter into an active operational mode in which the first mobile device 110 may enter into a sleep mode or hyphenate mode while the second mobile device 130 not only acquires information but also analyzes the acquired information to detect certain event. Once an event is detected (described in detail hereinafter), the second mobile device 130 then initiates a communication with the first mobile device 110 or wakes the first mobile device 110 for remote monitoring.

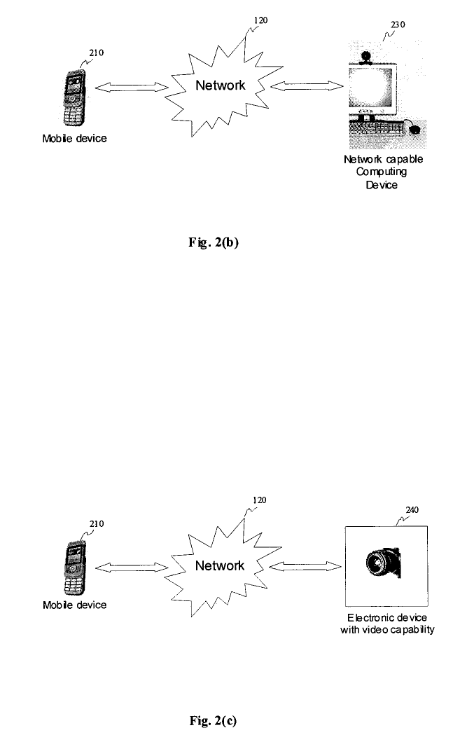

FIGS. 2(a)-2(c) depicts an exemplary systems in which different types of mobile devices work collaboratively for surveillance, according to an embodiment of the present teaching. In FIG. 2(a), a mobile phone 220 with audio or video (A/V) capability is used as the second mobile device 130. Any mobile device 210 with corresponding capability may be used as the first mobile device 110. In FIG. 2(b), a network capable computing device 230 is connected with an information acquisition device (e.g., a video camera). In this embodiment, although the network capable computing device may not be equipped with information acquisition ability, it is capable of communicating with such an information acquisition device and together they serve as the second mobile device 130. For example, a laptop (mobile) connected to a video camera for acquiring information (as shown in FIG. 2) is capable of performing the functionality of the second mobile device 130.

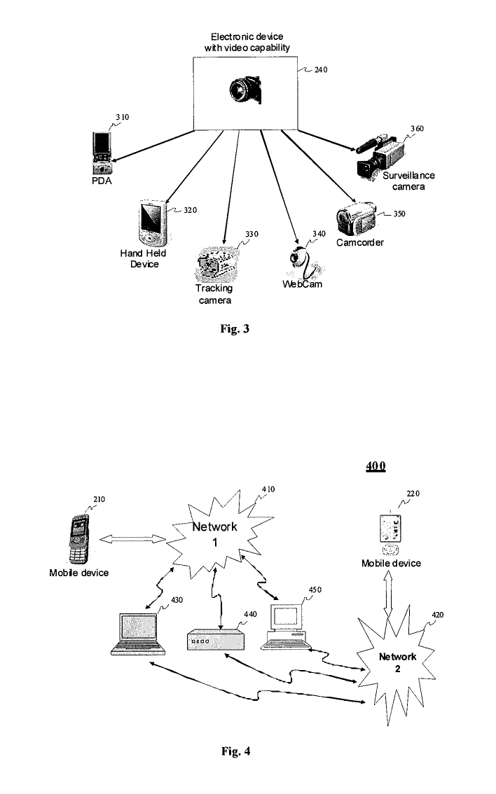

In FIG. 2(c), an electronic device 240 with video capability may also be used as the second mobile device 130. Various types of electronic devices may fall within this scope. FIG. 3 shows exemplary types of electronic devices with video capabilities. For example, an electronic device 240 with video capabilities includes a personal data assistance 310 (PDA), a hand held device 320, a video camera 330, a web camera 340, a camcorder 350, and any surveillance camera 360 that can be installed in a flexible manner.

FIG. 4 depicts an exemplary system 400 in which mobile devices collaborate to conduct surveillance via electronic devices connected through networks, according to an embodiment of the present teaching. In FIG. 4, the mobile device 210 and the mobile device 220 interface with different networks 410 and 420, respectively. Via the network 410, the mobile device 210 interacts with any of electronic devices 430, 440, . . . , 450, which may serve as an intermediary to connect to the mobile device 220 via the network 420. In this configuration, the electronic devices 430, 440, . . . , 450 may be used simply as a relay or a distributed component working collaboratively with the mobile device 220 to behave collectively as the second mobile device 130 (see FIG. 1). Alternatively, the electronic devices 430, 440, . . . , 450 may also serve as a relay or a distributed component working collaboratively with the mobile device 210 to behave collectively as the first mobile device 110 (see FIG. 1).

While serving as a relay, the electronic devices 430, 440, . . . , 450 may simply forwarding information between the mobile devices 210 and 220. While serving as a distributed component, the electronic devices 430, 440, . . . , and 450 may process information received from a mobile device and send the processed information to the other mobile device. For instance, a computer located in a household may be used to receive information from a mobile device located outside of the household (e.g., 210) via the Internet (e.g., network 1 410) and passes on the information received to a mobile device located inside of the household (e.g., 220) via a network inside of the household (e.g., the LAN network).

The information passed from the outside of the household to the mobile device inside of the household may be instructions to activate the mobile device inside of the household to perform surveillance operation. In the meantime, surveillance information acquired by the mobile device inside of the household may be transmitted via the internal network (LAN) to the mobile device located outside of the household via the electronic devices 430, 440, . . . , 450 through the network 410. Alternatively, signals received by the electronic devices may be processed to, e.g., extract useful information or generating modified information. For instance, an electronic device (e.g., a laptop) may further compress video information from the mobile device located inside of the household before sending it to the mobile device located outside of the household due to bandwidth considerations. In addition, an electronic device receiving video from a mobile device acquiring video inside of the household may enhance the contrast of the video images before sending it to the mobile device located outside. The level of modification made to the video on the contrast may be based on an instruction received earlier from the mobile device located outside of the household. In this manner, the electronic device and the mobile device inside act as an collective and each perform different functions to achieve surveillance for the household.

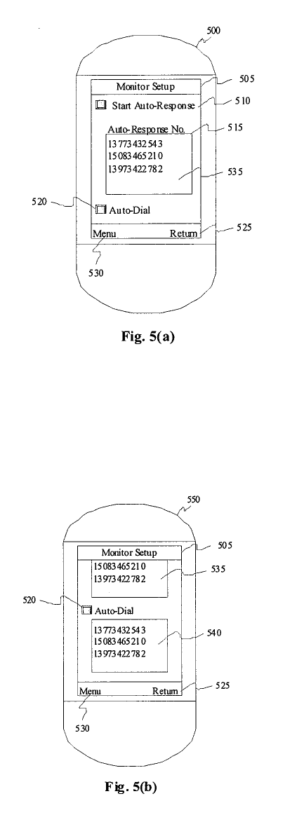

FIG. 5(a) shows an exemplary monitor setup interface 505 of a mobile device 500 in connection with surveillance functions, according to an embodiment of the present teaching. The exemplary interface 505 has a section called “Start Auto-Response” which has a list of auto-response numbers 535. For example, there are three numbers 13773432543, 15083465210, and 13973422782 are listed, respectively. Those numbers may correspond to identifications that the mobile device 500 can recognize as designated numbers that are used in association with remote surveillance by collaborating with another mobile device.

When the mobile device 500 receives a call, it may check whether the call is from any one of the designated numbers. If it is from a designated numbers, the mobile device 500 may enter into an auto-response mode. If the mobile device 500 is for surveillance (e.g., placed at household for monitoring an area), it may activate its monitoring capability by starting surveillance of a locale where it is placed, e.g., acquiring video of an area and sending the acquired information to the mobile device corresponding to the calling mobile device. Alternatively, if the mobile device 500 is for monitoring the surveillance (e.g., outside of a household), it may automatically respond to the call by starting reception of surveillance information (e.g., receiving and displaying video information).

On interface 505, there may be other functional keys to enable other capabilities. For example, there is a menu button 530 that may allow a user to see what other options available. There is also a “Return” button 525 that may allow a user to return to a previous menu. The “Auto-Dial” button 520 may be used by a user to check designated numbers that the mobile device may be able to connect for surveillance purposes. This is shown in FIG. 5(b), in which a list of auto-dial numbers 540, any one of which may be used to establish a communication channel with another corresponding mobile device and to activate that mobile device to remotely start surveillance and send the surveillance data to the calling mobile device.

In some embodiments, using the “Menu” button 530, a user may invoke more optional control capabilities (not shown). For example, various instruction options may be invoked and a user may use such instructions to remotely control the behavior of a mobile device in terms of how to acquire surveillance information. For instance, a user using a mobile device to receive surveillance information from another mobile device (e.g., activated previously by it) may need to control the quality of the pictures received in order to be able to see the scene being monitored.

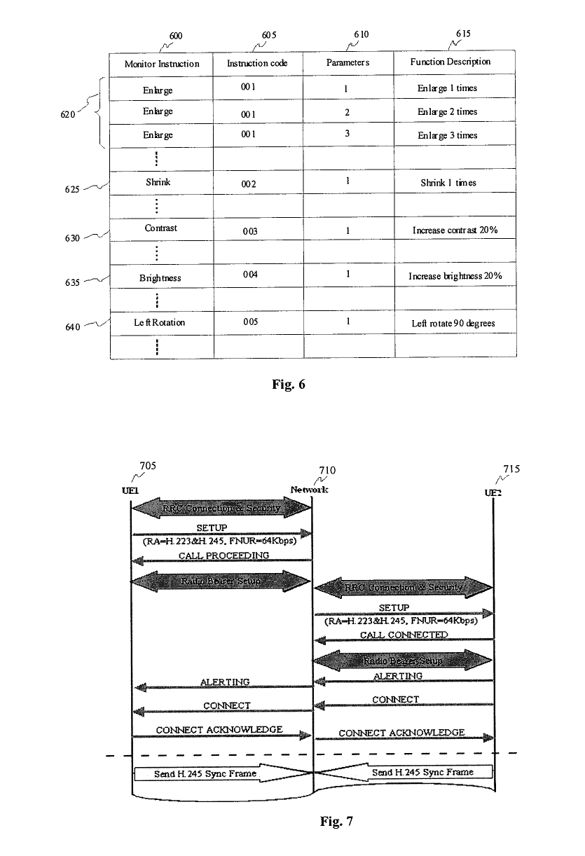

FIG. 6 illustrates exemplary instructions used in connection with surveillance via collaborative mobile devices, according to an exemplary embodiment of the present teaching. For instance, for video based surveillance, in the table shown in FIG. 6, column 600 provides a list of exemplary instructions, including instructions controlling enlargement of pictures 620, instructions controlling shrinking of pictures 625, instructions controlling contrast of pictures 630, instructions controlling brightness of pictures 635, and instructions controlling rotation of pictures 640. Column 605 provides exemplary codes representing corresponding instructions, column 610 provides exemplary control parameters used in instructions (e.g., enlarge instruction can have different parameters indicating different degrees of enlargement), and column 615 provides description of the control function to be achieved via individual instructions. For instance, with parameter value 1 for instruction for brightness, it may indicate to increase the brightness by 20%. Parameter 1 used in conjunction with instruction for left rotation may indicate to rotate clockwise by 90 degrees.

According to an exemplary embodiment of the present teaching, for video based surveillance, the exemplary instructions may be coded in a format of “a specific surveillance instruction identifier+space+instruction code+parameter”. More specifically, the specific surveillance instruction identifier may be defined as “Monitor”, and may also be defined as other identifier or in other formats which facilitate realizing the remote control operation. It should be understood that the instructions shown in FIG. 6 are for illustrative purposes only, and other instructions may also be used in the surveillance and the instructions may be coded in other formats for the video based surveillance.

These exemplary instructions may be implemented via software or hardware. In addition, such implementation may be based on some standard protocol such as 3G-324M and introduce value-added additional or modifications to introduce features discussed herein according to the present teaching. When implemented in such exemplary manner, the application of surveillance may be realized by taking advantage of the widely used 3G network infrastructure. Other implementations utilizing different protocols or network standard may also be used to achieve the teachings discussed herein.

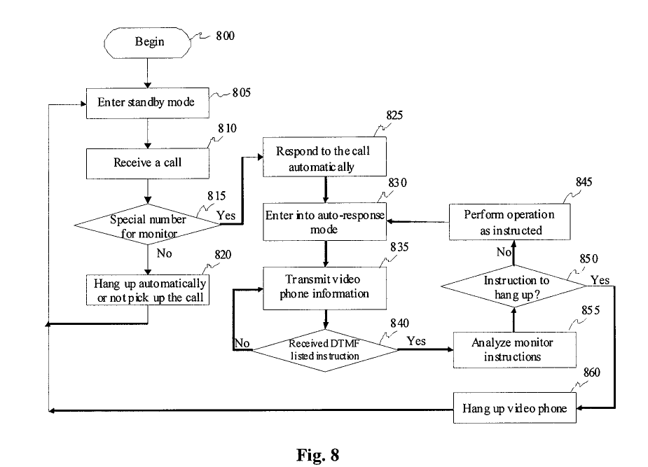

FIG. 7 depicts an exemplary communication protocol and information flow between different mobile devices to enable surveillance, according to an embodiment of the present teaching. In realizing the communication between mobile devices for surveillance, various communication protocols may be adopted. For example, the third generation wireless technologies, e.g., the 3G standard, may be adopted to implement the teaching discussed herein. Utilizing its bandwidth and the support for point-to-point video capabilities, 3G can be utilized for implementing the scheme of using mobile devices for surveillance. In the exemplary communication protocol as illustrated in FIG. 7, two mobile devices UE 1 705 and UE2 715 communicate via a network 710 according to the sequence of events illustrated in FIG. 7. It is understood that this exemplary protocol is merely illustrative and any other communication protocols may be used to achieve automatic communication for surveillance purposes.

FIG. 8 is a flowchart of an exemplary process in which a monitoring mobile device capable of being used as a surveillance terminal is remotely controlled by another activating mobile device for surveillance, according to an embodiment of the present teaching. Upon being placed at a locale to surveillance an area, a monitoring mobile device may first enter into, at 805, a standby mode, in which the mobile device may be at a state without activity yet capable of receiving signals. The monitoring mobile device remains in the standby mode until it receives, at 810, a request for communication or a call. Upon receiving the call, the monitoring mobile device examines, at 815, whether the call is from an identification or a number designated for surveillance. If the call is not from a designated identification or number, the mobile device may then hang up, at 820, the call or simply do not automatically pick up the call and then go back to standby mode at 805.

If the call is from a number designated for surveillance, the mobile phone automatically responds to the call from an activating mobile device attempting to activate the monitoring mobile device, at 825, and enter into an auto-response mode at 830. In the auto-response mode, the monitoring mobile phone may perform multiple functions, including acquiring information from the surveillance area and transmit, at 835, such acquired information to the activating mobile device. To surveillance the area, the monitoring mobile device may acquire information from the area of the locale. Such information may be audio, video, or combination thereof. The information to be acquired may be pre-determined or may be determined on the fly based on the designated number recognized. For example, a certain designated number may correspond to information of different modality or some combination. Therefore, by recognizing the designated number used for the call, the monitoring mobile phone may determine the operation needed to acquire information.

During the surveillance, the monitoring mobile device may also receive signals simultaneously. If such received signals correspond to dual tone multi-frequency (DTMF) listed instructions, determined at 840, sent from the activating mobile device, the monitoring mobile device analyzes, at 855, the received instruction and determines, at 850, whether the received instruction corresponds to an termination instruction. If the received instruction corresponds to a termination instruction, the monitoring mobile device terminates the surveillance operation, at 860, and return to the standby mode at 805. If the received instruction is not a termination instruction, the monitoring mobile device performs an operation as instructed at 845 and returns back to the auto-response mode at 830.

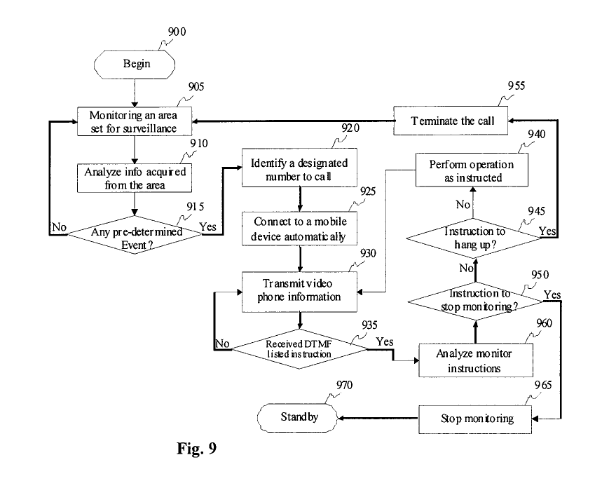

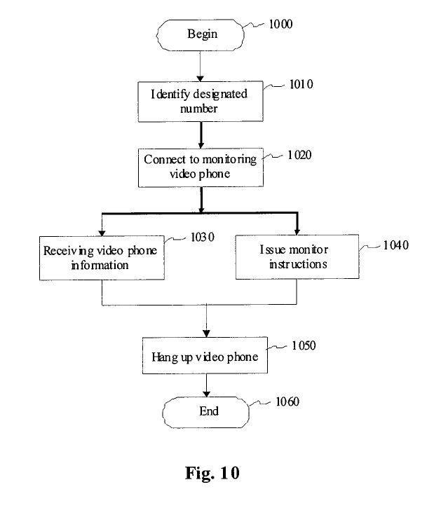

FIG. 9 is a flowchart of an exemplary process in which a monitoring mobile device operating as a surveillance terminal interacts with a remote mobile device for surveillance, according to an embodiment of the present teaching. In this embodiment, the monitoring mobile device actively surveillances an area of a locale where it is placed at 905. This may be done by acquire information from the area to be monitored and analyzes such acquired information, at 910, to detect certain pre-determined events. Exemplary events may include special audio sound (e.g., baby crying), particular visual event (e.g., fast moving object), or flashing light. If no such event is detected, determined at 915, the monitoring mobile device

If some pre-determine event is detected, the monitoring mobile device may operate to automatically make a contact to another remote mobile device. To do, the monitoring mobile device may automatically identify an auto-dial communication channel, at 920, designated to contact the remote mobile device and then automatically connect (dial) to the remote mobile device at 925. Once the connection to the remote mobile device is established, the monitoring mobile device transmits, at 930, the acquired information, optionally with information describing the detected event, to the remote mobile device.

Similarly, during the surveillance, the monitoring mobile device may also receive signals simultaneously. If such received signals correspond to dual tone multi-frequency (DTMF) listed instructions, determined at 935, sent from the remote mobile device, the monitoring mobile device analyzes, at 960, the received instruction and determines, at 950, whether the received instruction corresponds to an instruction to terminate the monitoring. If the received instruction corresponds to an instruction to stop monitoring, the monitoring mobile device terminates the surveillance operation, at 965, and enter into a standby mode at 970. When the monitoring mobile device enters into a standby mode, it behaves as a monitoring mobile device as described with reference to FIG. 8, in which the monitoring mobile device may need to be activated by the remote mobile device (now an activating mobile device).

If the received instruction is not an instruction for terminating the monitoring, the monitoring, the monitoring mobile device further determines, at 945, whether the received instruction is to terminate the connection with the remote mobile device (e.g., if a user of the remote mobile device decided, after reviewing the surveillance information received from the monitoring mobile device, that it is not worthwhile to continue the remote monitoring), the monitoring mobile device terminates the call, at 955, and returns back to the monitoring mode at 905. If the received instruction is neither to stop monitoring nor terminating the call, the monitoring mobile device performs an operation (e.g., adjusting contrast, brightness, or volume of the audio, etc.), at 940, with respect to the acquisition of the surveillance information and then applies the adjustment to the information transmitted to the remote mobile device at 930.

FIG. 10 is a flowchart of an exemplary process in which a control mobile device remotely collaborates with a monitoring mobile device to conduct surveillance, according to an embodiment of the present teaching. To activate a monitoring mobile device located remotely for surveillance an area of a locale where the monitoring mobile device is placed, a control mobile device identifies a designated communication channel (e.g., a designated number) at 1010. Based on the identified identification, the control mobile device connects, at 1020, to the monitoring mobile device (the monitoring mobile device recognizes the designated identification and enters into an auto-response mode to enable the connection).

Once the connection is made, the control mobile device receives surveillance information, at 1030, from the monitoring mobile device. At the same time, a user of the control mobile device may issue, at 1040, instructions to the monitoring mobile if there is a need to adjust any aspect of the information received. For instance, if the user desires to see more clearly any area of received video, the user may issue instructions to enlarge or zoom a certain portion of the video. Upon receiving such instructions, the control mobile device may then receive surveillance information updated in accordance with such issued instructions (at 1030). When the user desires to terminate the remote surveillance, the user may control to terminate the process by, e.g., hang up the control mobile device at 1050. In some embodiments, it is also feasible to issue a special instruction to terminate the surveillance. In some embodiments, such termination may be applied only to transmission. In some embodiments, such termination may stop the surveillance operation of the monitoring mobile device.

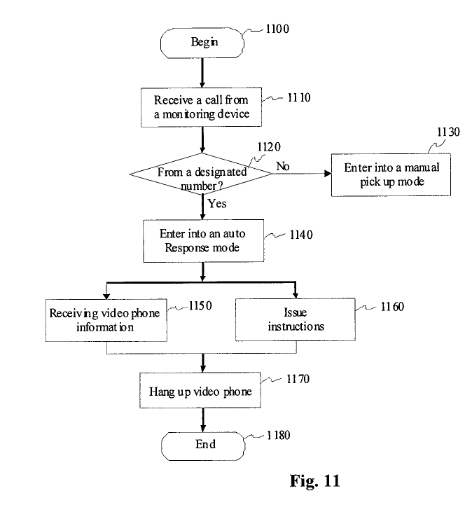

FIG. 11 is a flowchart of an exemplary process in which a control mobile device remotely contacted by a monitoring mobile device act collaboratively for surveillance, according to an embodiment of the present teaching. A control mobile device located outside of an area of a surveillance locale may initially be in a mode in which remote control of the surveillance is not activated (now shown). The control mobile device may then receive a call at 1110. It is automatically determined, at 1120, whether the call is from a channel designated for surveillance and corresponding to a remote monitoring mobile device. If the call is not from a designated channel, the control mobile device enters, at 1130, into a manual pick up mode. In this mode, it is up to the user of the control mobile device to determine whether he/she will respond to the call.

If the call is from a channel designated for surveillance, it is an indication that a remote monitoring mobile device initiated the call and want to connect. In this case, the control mobile device automatically enters into an auto-response mode at 1140. In some embodiments, it is also feasible to set the control mobile device to operate so that it allows a user to override the auto-response mode and proceed with manual response mode. In this case, the user can determine whether to respond to the call or not (now shown).

Once the connection is made, the control mobile device receives surveillance information, at 1150, from the monitoring mobile device. At the same time, a user of the control mobile device may issue, at 1160, instructions to the monitoring mobile if there is a need to adjust any aspect of the information received. For instance, if the user desires to see more clearly any area of received video, the user may issue instructions to enlarge or zoom a certain portion of the video. Upon receiving such instructions, the control mobile device may then receive surveillance information updated in accordance with such issued instructions (at 1150). When the user desires to terminate the remote surveillance, the user may control to terminate the process by, e.g., hang up the control mobile device at 1170. In some embodiments, it is also feasible to issue a special instruction to terminate the surveillance. In some embodiments, such termination may be applied only to transmission. In some embodiments, such termination may stop the surveillance operation of the monitoring mobile device.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A method for an audio or video (A/V) capable mobile device, comprising:
responding to a call from a mobile device at a locale where the A/V capable mobile device is placed for monitoring an area of the locale;
determining whether the call corresponds to a designated identification for activating the A/V capable mobile device to monitor the area of the locale; and
responding to the call from the mobile device if the call corresponds to the designated identification to activate the A/V capable mobile device, wherein
upon responding to the call, the A/V capable mobile device monitors the area of the locale.

2. The method according to claim 1, wherein
the A/V capable mobile device is a mobile phone; and
the mobile device is a mobile phone.

3. The method according to claim 2, wherein said monitor the area of the locale comprises:
acquiring information in connection with the area of the locale; and
transmitting the information of the area of the locale to the mobile device.

4. The method according to claim 3, wherein the information in connection with the area of the locale is video information.

5. The method according to claim 4, wherein the information in connection with the area of the locale is audio information.

6. The method according to claim 3, further comprising responding to an instruction from the mobile device with respect to the monitoring.

7. The method according to claim 6, wherein the responding to the instruction includes:
receiving an instruction from the mobile device;
adjusting the monitoring in connection with the area of the locale based on the received instruction; and
transmitting the information acquired based on the adjustment to the mobile device.

8. The method according to claim 7, wherein the instruction received from the mobile device includes at least one of:
an instruction for adjusting a parameter of a camera on the A/V capable mobile device; and
an instruction for adjusting a parameter for audio acquisition used in the A/V capable mobile device.

9. The method according to claim 8, wherein the instruction for adjusting a parameter of a camera includes:
an instruction for adjusting contrast of a picture acquired by the camera;
an instruction for adjusting a brightness of the picture acquired;
an instruction for adjusting the orientation of the camera; and
an instruction for adjusting a zoom of the camera.

10. The method according to claim 8, further comprising a termination instruction that instructs the A/V capable mobile device to terminate an operation.

11. The method according to claim 10, wherein the A/V capable mobile device terminates the operation upon receiving the termination instruction.

12. A method for an audio or video (A/V) capable mobile device, comprising:
monitoring an area of a locale, where the A/V capable mobile device is placed to monitor the area of the locale by acquiring information in connection with the area;
analyzing the acquired information to detect a pre-determined event;
automatically connecting to a mobile device based on a pre-determined channel designated to communicate with the mobile device regarding the information in connection with the area of the locale; and
transmitting information to the mobile device.

13. The method according to claim 12, wherein the information transmitted to the mobile device includes the information in connection with the area of the locale.

14. The method according to claim 12, wherein the information in connection with the area of the locale includes at least one of audio, video information, and a combination thereof.

15. The method according to claim 12, wherein the information transmitted to the mobile device includes information related to the pre-determined event.

16. The method according to claim 12, further comprising:
receiving an instruction from the mobile device; and
responding to the instruction.

17. The method according to claim 16, wherein the responding to the mobile device includes:
analyzing the instruction; and
adjusting the acquisition of the information in connection with the area of the locale based on the received instruction.

18. The method according to claim 17, wherein the instruction received from the mobile device includes at least one of:
an instruction for adjusting a parameter of a camera on the A/V capable mobile device; and
an instruction for adjusting a parameter for audio acquisition used in the A/V capable mobile device.

19. The method according to claim 17, further comprising transmitting the information acquired based on the adjustment to the mobile device.

20. The method according to claim 18, further comprising a termination instruction.

21. The method according to claim 20, wherein the termination instruction directs the A/V capable mobile device to terminate the connection to the mobile device.

22. The method according to claim 20, wherein the termination instruction directs the A/V capable mobile device to terminate the monitoring of the area upon receiving the termination instruction.

23. A method for a mobile device, comprising:
identifying a designated identification for activating an audio or video (A/V) capable mobile device placed at a locale for monitoring an area of the locale;
initiating a connection to the A/V capable mobile device by using the designated identification to activate the A/V capable mobile device;
receiving a signal from the A/V capable mobile device indicating that the monitoring operation is activated; and
receiving, from the A/V capable mobile device, information in connection with the monitoring of the area of the locale.

24. The method according to claim 23, wherein
the A/V capable mobile device is a mobile phone; and
the mobile device is a mobile phone.

25. The method according to claim 23, wherein said monitoring the area of the locale comprises:
acquiring information in connection with the area of the locale; and
transmitting the information of the area of the locale to the mobile device.

26. The method according to claim 25, wherein the information in connection with the area of the locale is at least one of audio and video information.

27. The method according to claim 23, further comprising sending to the A/V capable mobile device an instruction with respect to the monitoring.

28. The method according to claim 27, wherein the instruction sent to the A/V capable mobile device includes at least one of:
an instruction for adjusting a parameter of a camera on the A/V capable mobile device; and
an instruction for adjusting a parameter for audio acquisition used in the A/V capable mobile device.

29. The method according to claim 28, further comprising receiving the information in connection with the area of the locale acquired based on an adjustment made in accordance with the instruction.

30. The method according to claim 28, wherein the instruction for adjusting a parameter of a camera includes:
an instruction for adjusting contrast of a picture acquired by the camera;
an instruction for adjusting a brightness of the picture acquired;
an instruction for adjusting the orientation of the camera; and
an instruction for adjusting a zoom of the camera.

31. The method according to claim 28, further comprising a termination instruction that instructs the A/V capable mobile device to terminate an operation associated with the monitoring the area of the locale.

32. A method for a mobile device, comprising:
receiving a call from an audio or video (A/V) capable mobile device placed at a locale for monitoring an area of the locale;
determining whether the call corresponds to a designated identification for activating the mobile device;
automatically responding to the call if the call corresponds to the designated identification; and
receiving, from the A/V capable mobile device, information in connection with the monitoring of the area of the locale, wherein
the A/V capable mobile device places the call to the mobile device when the A/V capable mobile device detects a pre-determined event from information acquired by the A/V capable mobile device while the A/V capable mobile device monitors the area of the locale.

33. The method according to claim 32, further comprising sending to the A/V capable mobile device an instruction with respect to the monitoring.

34. The method according to claim 33, wherein the instruction sent to the A/V capable mobile device includes at least one of:
an instruction for adjusting a parameter of a camera on the A/V capable mobile device; and
an instruction for adjusting a parameter for audio acquisition used in the A/V capable mobile device.

35. The method according to claim 34, further comprising receiving the information in connection with the area of the locale acquired based on an adjustment made in accordance with the instruction.

36. The method according to claim 34, further comprising a termination instruction.

37. The method according to claim 36, wherein the termination instruction directs the A/V capable mobile device to terminate the connection.

38. The method according to claim 36, wherein the termination instruction directs the A/V capable mobile device to terminate monitoring the area of the locale.
